(19) United States
(12) Patent Application Publication
(10) Pub. No.: US 2026/0187565 A1
(43) Pub. Date: Jul. 2, 2026

(54) SYSTEM AND METHOD FOR AGENT-BASED SUPPLY CHAIN INCIDENT DETECTION AND ROOT CAUSE ANALYSIS

(71) Applicant: NIRMAL KUMAR JINGAR, Newton, MA (US)

(72) Inventor: NIRMAL KUMAR JINGAR, Newton, MA (US)

(21) Appl. No.: 19/533,374

(22) Filed: Feb. 9, 2026

(51) Int. Cl. G06Q 10/0637; G06Q 10/0635; G06Q 10/087

(52) U.S. Cl. CPC G06Q 10/0637; G06Q 10/0635; G06Q 10/087

(57) ABSTRACT

A system and method for agent-based supply chain incident detection and root cause analysis are disclosed. The method (300) includes receiving a plurality of operational signals from a plurality of supply chain nodes (104a, 104b, 104c . . . 104n). The method includes generating an autonomous analytical agent. The method includes detecting an incident condition based on the generated autonomous analytical agent. The method includes transmitting one or more anomaly context graphs across a distributed agent communication fabric based on the detected incident condition. The method includes executing a counterfactual causality evaluation over the one or more anomaly context graphs. The method includes detecting an incident taxonomy based on the counterfactual causality evaluation. The method includes generating a ranked set of mitigation strategies based on the detected incident taxonomy. The method includes applying at least one mitigation strategy to the plurality of supply chain nodes.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates generally to systems and methods for supply chain management. More particularly, to systems and methods for agent-based supply chain incident detection and root cause analysis.

### BACKGROUND OF THE INVENTION

Supply chains operate as complex, distributed networks involving multiple independent entities such as suppliers, manufacturers, logistics providers, warehouses, and fulfilment systems. The aforementioned entities generate large volumes of operational data reflecting inventory levels, production status, transportation movements, and demand fluctuations. The distributed and interconnected nature of such systems makes continuous monitoring and coordination increasingly challenging.

Operational disruptions in supply chains arise from a wide range of factors, including delays, resource shortages, equipment failures, data inconsistencies, and external events. Such disruptions often propagate across multiple nodes, leading to cascading effects that are not immediately observable at the point of origin. As a result, identifying the underlying cause of a disruption is frequently difficult, particularly when the initial triggering event occurs upstream or outside the immediate area of impact.

Existing supply chain monitoring approaches typically rely on centralized analytics platforms, predefined rules, or static threshold-based alerts. While the aforementioned approaches detect overt failures, they often struggle to capture subtle deviations in operational behavior or to distinguish between correlated events and actual causal factors. The aforementioned limitation can lead to delayed detection, false positives, or incomplete understanding of the incident.

Furthermore, conventional root cause analysis techniques are commonly performed manually or through offline analysis after an incident has already caused significant impact. Such techniques depend on historical reports or expert interpretation, which can be time-consuming and may not scale effectively in highly dynamic or large-scale supply chain environments.

In addition, response mechanisms for supply chain incidents are often reactive and disconnected from continuous monitoring processes. Corrective actions may be applied based on incomplete information, without systematic validation of whether the action addresses the true source of the problem. This can result in repeated disruptions, inefficient use of resources, and reduced operational resilience.

Therefore, there is a need to develop a system and method to overcome aforementioned problems.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for agent-based supply chain incident detection and root cause analysis is disclosed. The method includes receiving a plurality of operational signals from a plurality of supply chain nodes. The method includes generating an autonomous analytical agent for each of the plurality of supply chain nodes. The method includes detecting, by the autonomous analytical agent, an incident condition by computing a divergence metric between an observed state-transition trajectory and a predicted causal progression encoded in a probabilistic state-transition model and the generated autonomous analytical agent. The method includes transmitting one or more anomaly context graphs across a distributed agent communication fabric based on the detected incident condition. The method includes executing, by a root cause inference agent, a counterfactual causality evaluation over one or more anomaly context graphs by selectively suppressing one or more candidate causal nodes within the one or more anomaly context graphs by setting one or more corresponding transition probabilities and recomputing one or more downstream state-transition likelihoods. The method includes detecting an incident taxonomy based on the counterfactual causality evaluation. The method includes generating, by an action synthesis agent, a ranked set of mitigation strategies derived from one or more agent-level intervention outcomes based on the detected incident taxonomy. The method includes applying, in a closed-loop manner, at least one mitigation strategy to the plurality of supply chain nodes based on the generated ranked set of mitigation strategies.

In accordance with another embodiment of the present disclosure, a system for agent-based supply chain incident detection and root cause analysis is disclosed. The system includes a memory, at least one processor is operatively coupled to the memory. The at least one processor is configured to receive a plurality of operational signals from a plurality of supply chain nodes. The at least one processor is configured to generate an autonomous analytical agent for each of the plurality of supply chain nodes. The at least one processor is configured to detect, using the autonomous analytical agent, an incident condition by computing a divergence metric between an observed state-transition trajectory and a predicted causal progression encoded in a probabilistic state-transition model and the generated autonomous analytical agent. The at least one processor is configured to transmit one or more anomaly context graphs across a distributed agent communication fabric based on the detected incident condition. The at least one processor is configured to execute, using a root cause inference agent, a counterfactual causality evaluation over one or more anomaly context graphs by selectively suppressing one or more candidate causal nodes within the one or more anomaly context graphs by setting one or more corresponding transition probabilities and recomputing one or more downstream state-transition likelihoods. The at least one processor is configured to detect an incident taxonomy based on the counterfactual causality evaluation. The at least one processor is configured to generate, using an action synthesis agent, a ranked set of mitigation strategies derived from one or more agent-level intervention outcomes based on the detected incident taxonomy. The at least one processor is configured to apply, in a closed-loop manner, at least one mitigation strategy to the plurality of supply chain nodes based on the generated ranked set of mitigation strategies.

In accordance with another embodiment of the present disclosure, a non-transitory computer-readable medium storing instructions that, when executed, cause a processor to receive a plurality of operational signals from a plurality of supply chain nodes. The processor is configured to generate an autonomous analytical agent for each of the plurality of supply chain nodes. The processor is configured to detect, using the autonomous analytical agent, an incident condition by computing a divergence metric between an observed state-transition trajectory and a predicted causal progression encoded in a probabilistic state-transition model and the generated autonomous analytical agent. The processor is configured to transmit one or more anomaly context graphs across a distributed agent communication fabric based on the detected incident condition. The processor is configured to execute, using a root cause inference agent, a counterfactual causality evaluation over one or more anomaly context graphs by selectively suppressing the one or more candidate causal nodes within the one or more anomaly context graphs by setting one or more corresponding transition probabilities and recomputing one or more downstream state-transition likelihoods. The processor is configured to detect an incident taxonomy based on the counterfactual causality evaluation. The processor is configured to generate, using an action synthesis agent, a ranked set of mitigation strategies derived from one or more agent-level intervention outcomes based on the detected incident taxonomy. The processor is configured to apply, in a closed-loop manner, at least one mitigation strategy to the plurality of supply chain nodes based on the generated ranked set of mitigation strategies.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 is a block diagram depicting an environment FIG. 1 for establishing a system of agent-based supply chain incident detection and root cause analysis, in accordance with an embodiment of the present disclosure;

FIG. 2 is a block diagram depicting the system for agent-based supply chain incident detection and the root cause analysis, in accordance with an embodiment of the present disclosure; and

FIG. 3 illustrates a flow diagram depicting a method for agent-based supply chain incident detection and root cause analysis, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

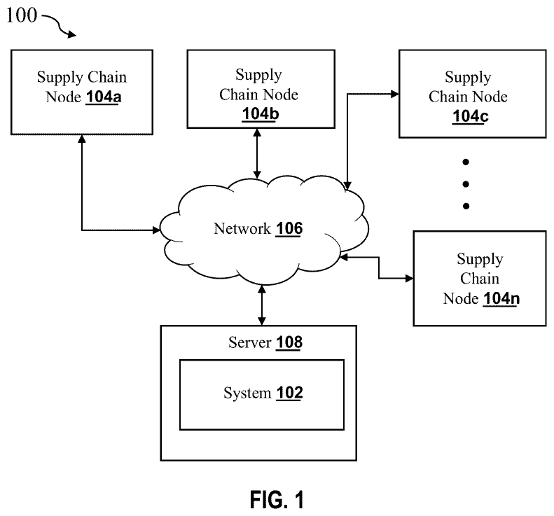

An environment and various implementations for environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail. The environment provides power of deep learning neural networks for data classification and clustering.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 is a block diagram 100 depicting an environment FIG. 1 for establishing a system 102 of agent-based supply chain incident detection and root cause analysis, in accordance with an embodiment of the present disclosure. The environment 100 may include a plurality of supply chain nodes 104a, 104b, 104c . . . 104n, a server 108, and a network 106. The plurality of supply chain nodes 104a, 104b, 104c . . . 104n (referred to herein as supply chain nodes 104a, 104b, 104c . . . 104n) may be communicated through the network 106.

The network 106 may include an internet. The network 106 may be rapidly emerging as a preferred system for distributing and exchanging data. The network 106 may include a cellular network, a public land mobile network (PLMN), a second generation (2G) network, a third generation (3G) network, a fourth generation (4G) network (e.g., a long-term evolution (LTE) network), a fifth generation (5G) network, and/or another network. Additionally, or alternatively, the network 106 may include a wide area network (WAN), a metropolitan network (MAN), a telephone network (e.g., the Public Switched Telephone Network (PSTN)), an ad hoc network, an intranet, an Internet, a fiber optic-based network, and/or a combination of these or other types of networks.

In an embodiment, the system 102 may be implemented within the server 108. In another embodiment, the system 102 may be externally connected to the server 108.

Yet, in another embodiment, some part of the system 102 may be implemented within the server 108 and remaining part of the system 102 may be externally connected to the server 108.

The system 102 may be configured to receive a plurality of operational signals (referred to herein as operational signals) from the plurality of supply chain nodes 104a, 104b, 104c . . . 104n (referred to herein as supply chain nodes 104a, 104b, 104c . . . 104n). The operational signals may include, but are not limited to, one or more of sensor telemetry, transactional event logs, inventory state updates, logistics tracking data, and demand forecast updates. Each of the operational signals associated with a corresponding supply chain node 104a, 104b, 104c . . . , or 104n. The supply chain nodes 104a, 104b, 104c . . . 104n may include, but are not limited to, a plurality of suppliers, a plurality of manufacturing systems, a plurality of logistics assets, a plurality of demand fulfillment platforms, and the like. In an embodiment, the system 102 may be configured to align the operational signals using time-normalization and event-sequencing logic prior to agent processing.

The system 102 may be configured to generate an autonomous analytical agent for each of the supply chain nodes 104a, 104b, 104c . . . 104n. In an embodiment, the system 102 may be configured to generate the autonomous analytical agent with a node-specific behavioral baseline derived from historical state-transition sequences associated with the respective supply chain node 104a, 104b, 104c . . . , or 104n.

The autonomous analytical agent may be defined as a software-executed computational entity instantiated within a processing environment associated with the respective supply chain node 104a, 104b, 104c . . . , or 104n. Depending on deployment architecture, the autonomous analytical agent may be implemented as a runtime process, containerized service, virtualized microservice instance, or embedded execution module operating on node-resident or edge computing infrastructure.

The autonomous analytical agent may operate within a defined compute boundary for example, within a warehouse management server, manufacturing execution platform, logistics tracking gateway, or edge analytics node and executes continuously or in an event-driven manner on streaming operational signals received from that supply chain node 104a, 104b, 104c . . . , or 104n.

In an embodiment, the system 102 may be configured to detect an incident condition based on the generated autonomous analytical agent. The incident condition may refer to a detected operational state in which observed behavior of the supply chain nodes 104a, 104b, 104c . . . 104n deviates from an expected operational pattern. The incident condition may correspond to an abnormal, unexpected, or inconsistent sequence of operational events and does not require an actual failure, delay, or threshold violation to have occurred. The incident condition may represent an early-stage or emerging disruption within the supply chain node 104a, 104b, 104c . . . , or 104n.

Further, the system 102 may be configured to compute a divergence metric between an observed state-transition trajectory and a predicted causal progression using one or more probabilistic likelihood ratios. The divergence metric may refer to a quantitative measure used to compare the observed state-transition trajectory with the predicted causal progression. The predicted causal progression may be represented as a directed state-transition graph encoding expected upstream and downstream dependencies for the respective supply chain node 104a, 104b, 104c . . . , or 104n.

In an embodiment, the divergence metric may be computed by comparing the observed state-transition trajectory with the predicted causal progression using one or more probabilistic or sequence-based divergence measures. The observed state-transition trajectory may be represented as an ordered sequence of operational states with associated transition probabilities derived from received operational signals. The predicted causal progression may be represented as a probabilistic state-transition model encoding expected transition likelihoods among corresponding states.

In an embodiment, the divergence metric may include a Kullback-Leibler divergence computed between an observed transition probability distribution and a predicted transition probability distribution across corresponding state pairs. In another embodiment, a Jensen-Shannon divergence may be computed to provide a symmetric divergence measure bounded within a predefined range.

In some implementations, the divergence metric may include a log-likelihood ratio computed by evaluating the likelihood of the observed trajectory under the predicted causal progression relative to an alternative or baseline progression model. The likelihood values may be derived from probabilistic state-transition matrices or sequence probability estimators.

In further embodiments, the divergence metric may include a sequence comparison measure computed between ordered state-transition sequences. The sequence comparison measure may include edit-distance computations, alignment scores, or transition mismatch counts reflecting structural deviation between observed and predicted trajectories.

Prior to divergence computation, the observed and predicted trajectories may be temporally normalized and mapped to a common state space to enable computational comparison. The resulting divergence metric may be used as an input to incident condition detection processes.

The divergence metric may indicate the degree to which the observed sequence of state transitions differs from the expected sequence. The divergence metric may be computed based on differences in transition probabilities, sequence ordering, timing, or structural alignment between the observed sequence of state transitions.

The observed state-transition trajectory may refer to an ordered sequence of operational states exhibited by the supply chain node 104a, 104b, 104c . . . , or 104n over time, as derived from the received operational signals. Each state transition may represent a change from one operational state to another based on observed events, measurements, or transactions. The observed state-transition trajectory may reflect the actual temporal progression of node behavior during system operation.

The system 102 may be configured to transmit one or more anomaly context graphs (referred to herein as anomaly context graphs) across a distributed agent communication fabric based on the detected incident condition. The anomaly context graphs may represent temporal ordering by associating the supply chain nodes 104a, 104b, 104c . . . 104n with time-based attributes indicating the sequence or timing of the operational events. The anomaly context graphs may further represent dependency strength among the supply chain nodes 104a, 104b, 104c . . . 104n. The dependency strength values may be derived from probabilistic state-transition models, historical interaction patterns, or observed co-occurrence frequencies.

In some implementations, the anomaly context graphs may be defined as a machine-readable structured data representation generated in response to detection of an incident condition. The anomaly context graphs may include nodes and edges configured to represent operational relationships associated with the detected incident.

The nodes of the anomaly context graphs may correspond to one or more of operational events, operational states, state transitions, or supply chain nodes. Each node may include associated attributes comprising a node identifier, node type, timestamp information, and one or more operational parameters derived from received operational signals. In certain embodiments, node attributes may further include state probability values, event classification indicators, or agent-origin metadata identifying the autonomous analytical agent that generated the node.

Edges of the anomaly context graphs may represent relationships between the nodes. Edge types may include temporal sequencing edges, dependency edges, and inferred impact propagation edges. Each edge may include associated attributes comprising dependency weights, confidence values, transition likelihood values, and temporal offsets representing the time interval between related nodes.

The anomaly context graph may be constructed by one or more autonomous analytical agents upon detection of an incident condition. Construction may include identifying incident-associated nodes, extract temporally proximate operational events, and establish edges based on observed state-transition relationships and modeled causal dependencies. In some implementations, probabilistic state-transition models may be used to assign dependency weights and confidence values to edges during graph formation.

The anomaly context graph may be incrementally updated as additional operational signals are received. Updating may include adding new nodes corresponding to subsequently observed events, modifying edge attributes based on recomputed dependency metrics, and merging graph segments received from peer agents via the distributed communication fabric. Version identifiers or sequence metadata may be associated with graph updates to maintain structural consistency across distributed agents. The resulting anomaly context graph may provide a structured representation suitable for downstream analytical processing, including a counterfactual causality evaluation and incident taxonomy detection.

The counterfactual causality evaluation may be performed by a root cause inference agent using the anomaly context graph as an input causal representation. The one or more candidate causal nodes may be selected based on structural and probabilistic attributes encoded within the anomaly context graph. Selection criteria may include temporal precedence relative to the detected incident condition, inbound and outbound dependency density, edge-weight aggregation values, or transition likelihood deviations associated with the node.

In some embodiments, the one or more candidate causal nodes whose outgoing dependency weights exceed a predefined threshold, or whose associated state-transition probabilities exhibit divergence from predicted causal progression models, are designated as the one or more candidate causal nodes. Candidate sets may be refined through filtering operations that exclude the one or more candidate causal nodes lacking temporal proximity or dependency connectivity to the incident condition.

For each candidate causal node, a counterfactual suppression operation may be performed to construct a hypothetical graph state representing system behavior in the absence of that node's causal influence. Suppression may be implemented in multiple non-limiting ways.

In one embodiment, the suppression may include removing the one or more candidate causal nodes and associated edges from the anomaly context graph. In an embodiment, the suppression may include neutralizing outgoing dependency edges by setting associated transition probability values to baseline or null values. In further embodiments, the suppression may include reparameterizing transition matrices by redistributing probability mass across alternate state-transition paths not involving the candidate causal node.

Following the suppression, downstream state-transition likelihoods may be recomputed for the one or more candidate causal nodes dependent on the suppressed candidate causal node. Recomputation may be performed using probabilistic state-transition models, Bayesian network inference, or Markovian progression estimators derived from predicted causal progression frameworks.

The recomputation process may generate a counterfactual state-transition trajectory representing expected operational evolution under the suppressed graph configuration. Transition likelihoods may be propagated iteratively across multi-hop dependency paths to reflect cumulative downstream impact.

Causal contribution associated with each candidate causal node may be quantified by comparing recomputed counterfactual likelihoods with observed state-transition likelihoods. Quantification metrics may include likelihood differentials, divergence values, propagation attenuation scores, or probability reduction ratios measured at the one or more candidate causal nodes.

In some embodiments, a causal contribution score may be generated for each candidate causal node based on aggregated downstream likelihood deviations. The one or more candidate causal nodes may be ranked according to the causal contribution score to identify a subset of nodes most strongly associated with the detected incident condition.

In an embodiment, the distributed agent communication fabric may refer to a decentralized communication layer that enables direct information exchange among a plurality of autonomous analytical agents. Within the distributed agent communication fabric, each of the plurality of autonomous analytical agents may operate as an independent peer and is capable of sending and receiving messages to and from other agents without reliance on a centralized coordinator, broker, or control node.

In an embodiment, the system 102 may include the root cause inference agent configured to execute the counterfactual causality evaluation over the anomaly context graphs. The counterfactual causality evaluation may refer to an analytical process for determining causal relationships associated with the incident condition by evaluating alternative hypothetical scenarios in which one or more candidate causal elements are selectively altered or suppressed.

The counterfactual causality evaluation may be performed using a structured representation of operational relationships, such as the anomaly context graphs. The system 102 may be configured to selectively suppress the one or more candidate causal nodes within the anomaly context graphs by setting one or more corresponding transition probabilities and recomputing one or more downstream state-transition likelihoods. The system 102 may be configured to identify a minimal causal subset responsible for the incident condition.

The system 102 may be configured to detect an incident taxonomy based on the counterfactual causality evaluation. The incident taxonomy may refer to a structured classification framework used to organize and label incident conditions detected within a supply chain environment. The incident taxonomy may define a set of incident categories, where each category corresponds to a distinct pattern of operational behavior or causal structure associated with the incident condition. The incident taxonomy category may be represented by a label, identifier, or descriptor that uniquely distinguishes one class of incident conditions from another.

In an embodiment, the system 102 may include an action synthesis agent configured to generate a ranked set of mitigation strategies derived from one or more agent-level intervention outcomes based on the detected incident taxonomy. The ranked set of mitigation strategies may refer to one or more defined operational actions generated in response to the detected incident condition and the detected incident taxonomy. Each mitigation strategy may represent a candidate intervention intended to modify one or more operational states or control parameters within the supply chain environment.

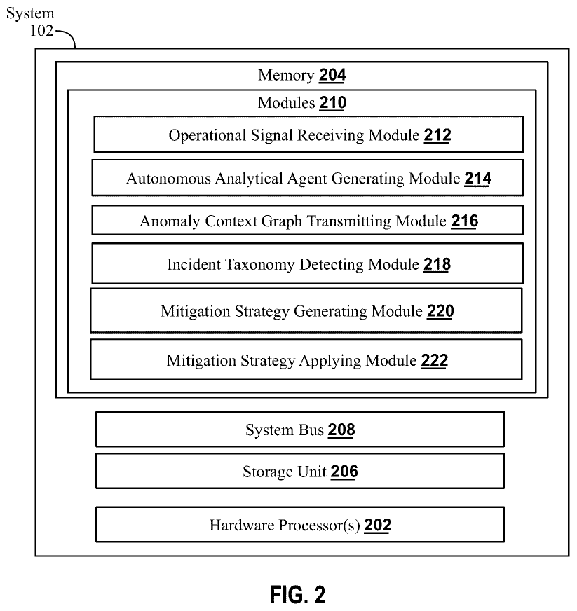

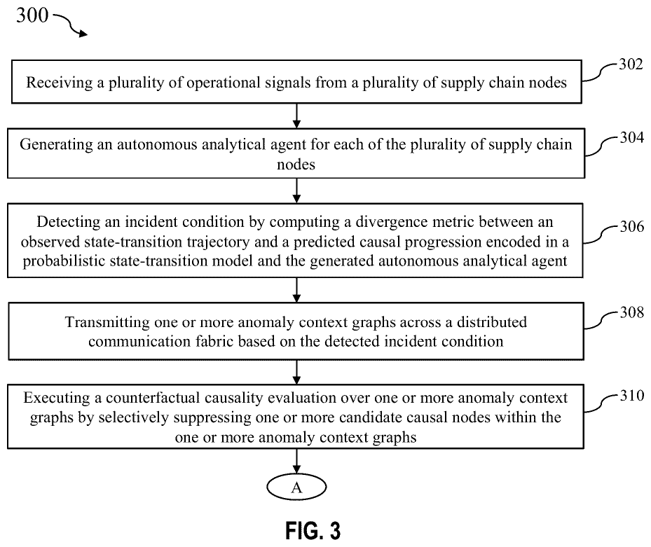

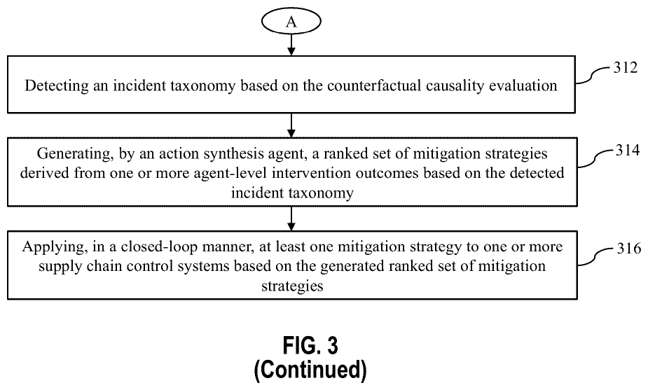

The ranked set of mitigation strategies may be associated with the one or more candidate causal nodes, state transitions, or supply chain nodes 104a, 104b, 104c . . . 104n identified as contributing to the incident condition. A mitigation strategy may include one or more control instructions, configuration changes, or operational adjustments applicable to supply chain control systems. The system 102 may be configured to apply at least one mitigation strategy to the supply chain nodes 104a, 104b, 104c . . . 104n in a closed-loop manner based on the generated ranked set of mitigation strategies. The system 102 has been further detailed with reference to FIG. 2 and FIG. 3.

FIG. 2 is a block diagram 200 depicting the system 102 for agent-based supply chain incident detection and the root cause analysis, in accordance with an embodiment of the present disclosure. According to FIG. 2, the system 102 may include one or more hardware processors 202, a memory 204 and a storage unit 206. The one or more hardware processors 202, the memory 204 and the storage unit 206 may be communicatively coupled through a system bus 208 or any similar mechanism. The memory 204 may include modules 210 in the form of programmable instructions executable by the one or more hardware processors 202. Further, the modules 210 may include an operational signal receiving module 212, an autonomous analytical agent generating module 214, an anomaly context graph transmitting module 216, an incident taxonomy detecting module 218, a mitigation strategy generating module 220, and a mitigation strategy applying module 222.

The operational signal receiving module 212 may be configured to receive the operational signals from the supply chain nodes 104a, 104b, 104c . . . 104n. The operational signal receiving module 212 may be configured to perform signal ingestion, formatting, and time-normalization to enable downstream analytical processing. The operational signal receiving module 212 may further associate the received operational signals with corresponding supply chain nodes 104a, 104b, 104c . . . 104n and maintain temporal sequence of the operational events.

In an example scenario, the operational signal receiving module 212 receives shipment tracking updates from a logistics management system, inventory level updates from a warehouse management system, and production completion events from a manufacturing execution system.

For instance, a shipment departure timestamp, pallet inventory counts, and machine production cycle completions are ingested as the operational signals. The operational signal receiving module 212 time-normalizes the operational signals and associates them with the supply chain nodes 104a, 104b, 104c . . . 104n, such as a specific warehouse, transport vehicle, and manufacturing facility, thereby creating a temporally ordered signal stream for downstream processing.

The autonomous analytical agent generating module 214 may be configured to generate the autonomous analytical agent for each of the supply chain nodes 104a, 104b, 104c . . . 104n. The autonomous analytical agent may be instantiated as a software entity associated with a respective node and is configured to analyze the operational signals corresponding to that node.

In some implementations, the autonomous analytical agent generating module 214 may be configured to provision each agent with node-specific analytical parameters, including behavioral baselines and state-transition representations derived from historical operational data. The generated the autonomous analytical agent may operate independently to monitor node-level operational states and detect deviations in observed state-transition trajectories.

In one scenario, the autonomous analytical agent generating module 214 provisions the autonomous analytical agent for a regional distribution warehouse. The autonomous analytical agent is configured using historical warehouse throughput data, dock loading durations, and dispatch sequencing records.

The generated autonomous analytical agent monitors the operational signals, such as truck arrival scans and loading completion events, and constructs observed state-transition trajectories reflecting warehouse operational flow. The agent maintains node-specific analytical parameters derived from historical operational behavior.

The anomaly context graph transmitting module 216 may be configured to transmit the anomaly context graphs generated in response to detected incident conditions. The anomaly context graphs may include structured representations of operational relationships, including temporal ordering, dependency strength, and confidence-weighted impact propagation paths.

In some implementations, the anomaly context graph transmitting module 216 may be configured to communicate the anomaly context graphs across the distributed agent communication fabric. Transmission may include routing structured graph data objects among the plurality of autonomous analytical agents, enabling distributed sharing of incident-related contextual information.

In an example scenario, the autonomous analytical agent associated with a manufacturing plant detects an incident condition based on an abnormal delay between component assembly and packaging stages. The anomaly context graph is generated representing related upstream supplier deliveries and downstream shipment schedules.

The anomaly context graph transmitting module 216 transmits the structured graph to other agents, including those monitoring supplier nodes and logistics carriers, via the distributed agent communication fabric. The transmitted graph includes temporal event ordering, dependency edges, and associated confidence values.

The incident taxonomy detecting module 218 may be configured to detect or assign the incident taxonomy corresponding to the detected incident condition. The incident taxonomy detecting module 218 may be configured to analyze outputs of the counterfactual causality evaluation processes, including identified causal nodes and causality indicators.

In one scenario, outputs of counterfactual causality evaluation identify that the detected incident condition is structurally similar to previously observed multi-node fulfillment disruptions. The incident taxonomy detecting module compares the anomaly context graph structure and causal indicators with stored taxonomy categories.

Based on the aforementioned comparison, the incident taxonomy detecting module 218 assigns the incident condition to an incident taxonomy category corresponding to coordinated upstream supply delay patterns. The taxonomy label is stored and associated with the incident record.

In some implementations, the incident taxonomy detecting module 218 may be configured to classify the incident condition into a taxonomy category based on structural similarity, causal patterns, or state-transition characteristics derived from anomaly context graphs. The module may maintain and update a taxonomy repository that stores incident classification labels and associated descriptors.

The mitigation strategy generating module 220 may be configured to generate the ranked set of mitigation strategies corresponding to the detected incident taxonomy. Each of the ranked set of mitigation strategies may represent a candidate operational intervention associated with the one or more candidate causal nodes or affected supply chain nodes 104a, 104b, 104c . . . 104n.

In an example scenario, the mitigation strategy generating module 220 generates the ranked set of mitigation strategies in response to the detected incident taxonomy. The ranked set of mitigation strategies include reallocating inventory from an alternate warehouse, modifying shipment routing sequences, and adjusting production batch prioritization.

Each mitigation strategy is defined as a machine-readable action set specifying the supply chain nodes 104a, 104b, 104c . . . 104n and operational parameters subject to modification. The mitigation strategy generating module 220 prepares the candidate strategies for downstream evaluation and ranking.

In some implementations, the mitigation strategy generating module 220 may be configured to synthesize mitigation strategies by generating machine-readable action definitions specifying operational parameters to be modified. The mitigation strategy generating module 220 may be configured to produce candidate strategies for comparative evaluation and ranking.

The mitigation strategy applying module 222 may be configured to apply at least one selected mitigation strategy to the supply chain nodes 104a, 104b, 104c . . . 104n. Application may include executing control instructions, configuration updates, or operational parameter modifications through programmable interfaces associated with the supply chain nodes 104a, 104b, 104c . . . 104n.

In some implementations, the mitigation strategy applying module 222 may be configured to apply the selected mitigation strategy in a closed-loop manner, post-application operational signals are monitored to reflect resulting state transitions for subsequent analytical processing.

In one scenario, a selected mitigation strategy involves rerouting outbound shipments through an alternate logistics hub. The mitigation strategy applying module 222 executes control instructions via a programmable logistics management interface associated with the affected carrier systems.

Following application, the mitigation strategy applying module 222 continues receiving updated shipment movement signals reflecting revised routing paths. These post-application signals are made available for subsequent monitoring and analysis within the system.

In an embodiment, the root cause analysis may be performed through a distributed analytical process that evaluates causal relationships associated with the detected incident condition across the supply chain nodes 104a, 104b, 104c . . . 104n. Upon detection of the incident condition by the plurality of autonomous analytical agents, the anomaly context graph is generated to represent operational relationships associated with the incident condition. The anomaly context graph may include nodes corresponding to operational states, events, or supply chain entities, and edges representing temporal sequencing relationships, dependency relationships, and inferred influence paths.

The anomaly context graph may be transmitted across the distributed agent communication fabric, enabling the plurality of autonomous analytical agents to contribute contextual operational data. Each participating agent may augment the anomaly context graph by appending locally observed state transitions, dependency indicators, or confidence values associated with node-level observations.

Further, the root cause inference agent may perform causal analysis using the aggregated anomaly context graph. The root cause inference agent identifies one or more candidate causal nodes within the anomaly context graph based on structural positioning, temporal precedence, and dependency linkages relative to the detected incident condition.

The root cause inference agent executes a counterfactual causality evaluation to assess the contribution of each candidate causal node. Counterfactual evaluation may include selectively suppressing a candidate causal node within the anomaly context graph and recomputing downstream state-transition likelihoods associated with dependent nodes.

The suppression of a candidate causal node may include removing the node, neutralizing associated dependency edges, or recalibrating transition probability values linked to the node. Following the suppression, the system 102 may compute a hypothetical state-transition progression representing operational behavior in the absence of the candidate causal node.

The recomputed progression may be compared with the observed state-transition trajectory to determine the degree of causal influence attributable to the suppressed node. This process may be iteratively performed for multiple candidate causal nodes, either individually or in defined combinations.

The root cause analysis process may be executed iteratively as additional operational signals are received and incorporated into the anomaly context graph. Updated causal evaluations may be performed to reflect evolving operational conditions within the supply chain environment.

FIG. 3 illustrate a flow diagram depicting a method 300 for agent-based supply chain incident detection and root cause analysis, in accordance with an embodiment of the present disclosure.

Referring to FIG. 3, at step 302, the method 300 may include receiving the plurality of operational signals from the supply chain nodes 104a, 104b, 104c . . . 104n.

At step 304, the method 300 may include generating the autonomous analytical agent for each of the supply chain nodes 104a, 104b, 104c . . . 104n.

At step 306, the method 300 may include detecting, by the autonomous analytical agent, the incident condition by computing the divergence metric between the observed state-transition trajectory and the predicted causal progression encoded in the probabilistic state-transition model and the generated autonomous analytical agent.

At step 308, the method 300 may include transmitting the one or more anomaly context graphs across the distributed agent communication fabric based on the detected incident condition.

At step 310, the method 300 may include executing, by the root cause inference agent, the counterfactual causality evaluation over the one or more anomaly context graphs by selectively suppressing the one or more candidate causal nodes within the one or more anomaly context graphs by setting the one or more corresponding transition probabilities and recomputing the one or more downstream state-transition likelihoods.

Referring to FIG. 3, at step 312, the method 300 may include detecting the incident taxonomy based on the counterfactual causality evaluation.

At step 314, the method 300 may include generating, by the action synthesis agent, the ranked set of mitigation strategies derived from the one or more agent-level intervention outcomes based on the detected incident taxonomy.

At step 316, the method 300 may include applying, in the closed-loop manner, the at least one mitigation strategy to the supply chain nodes 104a, 104b, 104c . . . 104n based on the generated ranked set of mitigation strategies.

In an embodiment, to generate the autonomous analytical agent for each of the supply chain nodes 104a, 104b, 104c . . . 104n, the method 300 may include generating the autonomous analytical agent with the node-specific behavioral baseline derived from the historical state-transition sequences associated with the respective supply chain node.

The method 300 may include updating node-specific behavioral baseline using a sliding temporal window that excludes one or more outlier state transitions exceeding a predefined confidence threshold.

In an embodiment, to detect the incident condition, the method 300 may include computing the divergence metric between the observed state-transition trajectory and the predicted causal progression using the one or more probabilistic likelihood ratios. The method 300 may include detecting the incident condition based on the computed divergence metric between the observed state-transition trajectory and the predicted causal progression.

In an embodiment, to detect the incident taxonomy, the method 300 may include assigning the incident condition to a generated taxonomy label derived from structural similarity between the one or more anomaly context graphs based on the counterfactual causality evaluation. The method 300 may include detecting the incident taxonomy based on the counterfactual causality evaluation. The one or more anomaly context graphs may encode temporal ordering, dependency strength, and one or more confidence-weighted impact propagation paths across the supply chain nodes 104a, 104b, 104c . . . 104n.

In an embodiment, to generate the ranked set of mitigation strategies, the method 300 may include emulating the one or more agent-level intervention outcomes by modifying the state-transition parameters within the virtual execution environment based on the detected incident taxonomy. The method 300 may include generating, by the action synthesis agent, the ranked set of mitigation strategies derived from the one or more agent-level intervention outcomes based on the detected incident taxonomy.

In an embodiment, to apply the at least one mitigation strategy, the method 300 may include applying the at least one mitigation strategy through a programmable interface of the supply chain nodes 104a, 104b, 104c . . . 104n.

The method 300 may include updating, by the autonomous analytical agent, the probabilistic state-transition model that encodes one or more expected causal progressions among one or more upstream operational events, one or more midstream operational events, and one or more downstream operational events based on the generated autonomous analytical agent.

The methods may be implemented in any suitable hardware, software, firmware, or combination thereof.

Thus, various embodiments of the present invention provide the system for enabling incident detection to be performed in a distributed manner through autonomous analytical agents provisioned at respective supply chain nodes. The present invention analyzes node-level operational signals locally, the system supports detection of incident conditions based on state-transition behavior specific to each node, rather than relying solely on centralized monitoring constructs.

The present invention evaluates divergence between observed state-transition trajectories and predicted causal progressions, the invention facilitates identification of anomalous operational patterns prior to manifestation of explicit operational failures or threshold breaches. The present invention enables detection of incident conditions at intermediate stages of disruption propagation. The present invention provides a structured representation of incident-related operational relationships. The anomaly context graphs encode temporal ordering, dependency strength, and impact propagation paths, thereby enabling incident conditions to be analyzed within a multi-node contextual framework rather than as isolated node-level events.

The present invention enables direct exchange of anomaly context information among autonomous analytical agents. The present invention supports distributed situational awareness and facilitates aggregation of incident context without requiring centralized message brokering or orchestration layers. The present invention performs using counterfactual causality evaluation, wherein candidate causal nodes are selectively suppressed and downstream state-transition likelihoods are recomputed. The present invention enables causal contribution to be assessed through hypothetical progression re-computation rather than correlation-based inference alone.

The present invention incorporates incident taxonomy detection based on causal structures and anomaly context graph characteristics. The taxonomy framework supports dynamic generation and refinement of incident categories, enabling classification constructs to evolve in response to newly observed incident patterns.

Mitigation strategies are generated as machine-readable intervention constructs derived from causal analysis outputs and incident taxonomy classifications. Candidate strategies are formulated with respect to identified causal nodes and affected supply chain entities, enabling structured response planning.

Application of mitigation strategies is performed through programmable interfaces associated with supply chain control systems. Post-application operational signals are monitored and incorporated into subsequent analytical cycles, enabling closed-loop observation of resulting state transitions.

The present invention distributes analytical processing across autonomous agents and enabling distributed contextual exchange, the invention supports scalable deployment across geographically dispersed and operationally heterogeneous supply chain environments.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A method for agent-based supply chain incident detection and root cause analysis, the method comprising:
receiving a plurality of operational signals from a plurality of supply chain nodes;
generating an autonomous analytical agent for each of the plurality of supply chain nodes;
detecting, by the autonomous analytical agent, an incident condition by computing a divergence metric between an observed state-transition trajectory and a predicted causal progression encoded in a probabilistic state-transition model and the generated autonomous analytical agent;
transmitting one or more anomaly context graphs across a distributed agent communication fabric based on the detected incident condition;
executing, by a root cause inference agent, a counterfactual causality evaluation over the one or more anomaly context graphs by selectively suppressing one or more candidate causal nodes within the one or more anomaly context graphs by setting one or more corresponding transition probabilities and recomputing one or more downstream state-transition likelihoods;
detecting an incident taxonomy based on the counterfactual causality evaluation;
generating, by an action synthesis agent, a ranked set of mitigation strategies derived from one or more agent-level intervention outcomes based on the detected incident taxonomy; and
applying, in a closed-loop manner, at least one mitigation strategy to the plurality of supply chain nodes based on the generated ranked set of mitigation strategies.

2. The method of claim 1, wherein the plurality of operational signals comprises one or more of sensor telemetry, transactional event logs, inventory state updates, logistics tracking data, and demand forecast updates, wherein each of the plurality of operational signals associated with a corresponding supply chain node.

3. The method of claim 1, wherein generating the autonomous analytical agent for each of the plurality of supply chain nodes comprises:
generating the autonomous analytical agent with a node-specific behavioral baseline derived from historical state-transition sequences associated with the respective supply chain node.

4. The method of claim 3, comprising:
updating node-specific behavioral baseline using a sliding temporal window that excludes one or more outlier state transitions exceeding a predefined confidence threshold.

5. The method of claim 1, wherein detecting the incident condition comprises:
computing the divergence metric between the observed state-transition trajectory and the predicted causal progression using one or more probabilistic likelihood ratios; and
detecting the incident condition based on the computed divergence metric between the observed state-transition trajectory and the predicted causal progression.

6. The method of claim 1, wherein detecting the incident taxonomy comprises:
assigning the incident condition to a generated taxonomy label derived from structural similarity between the one or more anomaly context graphs based on the counterfactual causality evaluation; and
detecting the incident taxonomy based on the counterfactual causality evaluation.

7. The method of claim 1, wherein generating the ranked set of mitigation strategies comprises:
emulating one or more agent-level intervention outcomes by modifying state-transition parameters within a virtual execution environment based on the detected incident taxonomy; and
generating, by an action synthesis agent, the ranked set of mitigation strategies derived from the one or more agent-level intervention outcomes based on the detected incident taxonomy.

8. The method of claim 1, wherein applying the at least one mitigation strategy comprises:
applying the at least one mitigation strategy through a programmable interface of the plurality of supply chain nodes.

9. The method of claim 1, comprising:
updating, by the autonomous analytical agent, the probabilistic state-transition model that encodes one or more expected causal progressions among one or more upstream operational events, one or more midstream operational events, and one or more downstream operational events based on the generated autonomous analytical agent.

10. The method of claim 1, wherein the one or more anomaly context graphs encodes temporal ordering, dependency strength, and one or more confidence-weighted impact propagation paths across the plurality of supply chain nodes.

11. A system for agent-based supply chain incident detection and root cause analysis, the system comprising:
a memory;
at least one processor is operatively coupled to the memory, wherein the at least one processor is configured to:
receive a plurality of operational signals from a plurality of supply chain nodes;
generate an autonomous analytical agent for each of the plurality of supply chain nodes;
detect, using the autonomous analytical agent, an incident condition by computing a divergence metric between an observed state-transition trajectory and a predicted causal progression encoded in a probabilistic state-transition model and the generated autonomous analytical agent;
transmit one or more anomaly context graphs across a distributed agent communication fabric based on the detected incident condition;
execute, using a root cause inference agent, a counterfactual causality evaluation over one or more anomaly context graphs by selectively suppressing one or more candidate causal nodes within the one or more anomaly context graphs by setting one or more corresponding transition probabilities and recomputing one or more downstream state-transition likelihoods;
detect an incident taxonomy based on the counterfactual causality evaluation;
generate, using an action synthesis agent, a ranked set of mitigation strategies derived from one or more agent-level intervention outcomes based on the detected incident taxonomy; and
apply, in a closed-loop manner, at least one mitigation strategy to the plurality of supply chain nodes based on the generated ranked set of mitigation strategies.

12. The system of claim 11, wherein the plurality of operational signals comprises one or more of sensor telemetry, transactional event logs, inventory state updates, logistics tracking data, and demand forecast updates, wherein each of the plurality of operational signals associated with a corresponding supply chain node.

13. The system of claim 11, wherein to generate the autonomous analytical agent for each of the plurality of supply chain nodes, the at least one processor is configured to:
generate the autonomous analytical agent with a node-specific behavioral baseline derived from historical state-transition sequences associated with the respective supply chain node.

14. The system of claim 13, wherein the at least one processor is configured to:
update node-specific behavioral baseline using a sliding temporal window that excludes one or more outlier state transitions exceeding a predefined confidence threshold.

15. The system of claim 11, wherein to detect the incident condition, the at least one processor is configured to:
compute the divergence metric between the observed state-transition trajectory and the predicted causal progression using one or more probabilistic likelihood ratios; and
detect the incident condition based on the computed divergence metric between the observed state-transition trajectory and the predicted causal progression.

16. The system of claim 11, wherein to detect the incident taxonomy, the at least one processor is configured to:
assign the incident condition to a generated taxonomy label derived from structural similarity between the one or more anomaly context graphs based on the counterfactual causality evaluation; and
detect the incident taxonomy based on the counterfactual causality evaluation.

17. The system of claim 11, wherein to generate the ranked set of mitigation strategies, the at least one processor is configured to:
emulate one or more agent-level intervention outcomes by modifying state-transition parameters within a virtual execution environment based on the detected incident taxonomy; and
generate, by an action synthesis agent, the ranked set of mitigation strategies derived from the one or more agent-level intervention outcomes based on the detected incident taxonomy.

18. The system of claim 11, wherein to apply the at least one mitigation strategy, the at least one processor is configured to:
apply the at least one mitigation strategy through a programmable interface of the plurality of supply chain nodes.

19. The system of claim 11, wherein the at least one processor is configured to:
update, using the autonomous analytical agent, a probabilistic state-transition model that encodes one or more expected causal progressions among one or more upstream operational events, one or more midstream operational events, and one or more downstream operational events based on the generated autonomous analytical agent.

20. A non-transitory computer-readable medium storing instructions that, when executed, cause a processor to:
receive a plurality of operational signals from a plurality of supply chain nodes;
generate an autonomous analytical agent for each of the plurality of supply chain nodes;
detect, using the autonomous analytical agent, an incident condition by computing a divergence metric between an observed state-transition trajectory and a predicted causal progression encoded in a probabilistic state-transition model and the generated autonomous analytical agent;
transmit one or more anomaly context graphs across a distributed agent communication fabric based on the detected incident condition;
execute, using a root cause inference agent, a counterfactual causality evaluation over one or more anomaly context graphs by selectively suppressing one or more candidate causal nodes within the one or more anomaly context graphs by setting one or more corresponding transition probabilities and recomputing one or more downstream state-transition likelihoods;
detect an incident taxonomy based on the counterfactual causality evaluation;
generate, using an action synthesis agent, a ranked set of mitigation strategies derived from one or more agent-level intervention outcomes based on the detected incident taxonomy; and
apply, in a closed-loop manner, at least one mitigation strategy to the plurality of supply chain nodes based on the generated ranked set of mitigation strategies.
